(19) United States
(12) Patent Application Publication
(10) Pub. No.: US 2014/0136410 A1
(43) Pub. Date: May 15, 2014

(54) Credit Card Fraud Detection

(71) Applicants: Jeremiah Joseph Akin, Pleasant Hill, CA (US); Frank Anthony Nuzzi, Pflugerville, TX (US)

(72) Inventors: Jeremiah Joseph Akin, Pleasant Hill, CA (US); Frank Anthony Nuzzi, Pflugerville, TX (US)

(21) Appl. No.: 13/673,780

(22) Filed: Nov. 9, 2012

(51) Int. Cl. G06Q 40/00

(52) U.S. Cl. CPC G06Q 20/4016
USPC 705/44

(57) ABSTRACT

Methods and systems are provided for detecting and preventing fraudulent use of credit cards and the like. The amount of wear of a magnetic strip of a suspect credit card can be compared to an amount of wear of the magnetic strip of the corresponding legitimate credit card. If the amount of wear of the magnetic strip of the suspect credit card is less than the amount of wear of the magnetic strip of the legitimate credit card, then both the suspect credit card and the legitimate credit card can be deactivated.

### BACKGROUND

1. Technical Field

The present disclosure generally relates to credit cards and, more particularly, relates to electronic methods and systems for detecting credit card fraud.

2. Related Art

Credit cards are well known. It has been estimated that over 600 million credit cards are held by U.S. consumers. The average number of credit cards held by each card holder was 3.5 cards in 2008. The popularity of credit cards has made them an attractive target for fraud. The cost of credit card fraud is substantial. In 2006, the cost of credit card fraud was estimated to be seven cents for each one dollar's worth of credit card transactions.

One way by which credit card fraud can occur is the unauthorized duplication and use of a legitimate credit card. A fraudster can obtain legitimate credit card information, such as the cardholder's name, credit card number, and expiration date. The information can be obtained indirectly, such as by hacking a server of a credit card company. The information can be obtained directly from the cardholder's credit card, such as when the cardholder gives the credit card to a waitress or waiter at a restaurant to pay a bill, thus giving the waitress or waiter an opportunity to copy the information.

Once the fraudster has the cardholder's information, the fraudster can use a machine to emboss a blank credit card, print upon the credit card, and to write the necessary information onto a magnetic strip on the back of the new credit card. Once this is done, the unauthorized, i.e., fake, new credit card can be used as though it was the corresponding legitimate credit card. Such unauthorized use can continue until the fraud is recognized, thereby costing cardholders, merchants, banks, and/or credit card companies a substantial amount of money.

### BRIEF DESCRIPTION OF THE DRAWINGS

FIG. 1 is a block diagram of a system for detecting credit card fraud, according to an embodiment;

FIG. 2 is a flow chart showing a method for detecting credit card fraud, according to an embodiment;

FIG. 3 is a flow chart showing further detail of the method for detecting credit card fraud, according to an embodiment;

FIG. 4 is a block diagram of an example of a computer that is suitable for use in the system for detecting credit card fraud, according to an embodiment;

FIG. 5 shows an example of a credit card configured for detecting credit card fraud, according to an embodiment; and

FIG. 6 shows another example of a credit card configured for detecting credit card fraud, according to an embodiment.

### DETAILED DESCRIPTION

Methods and systems are provided for detecting and preventing fraudulent use of credit cards and the like. According to an embodiment, the amount of wear of a suspect credit card, such as of a magnetic strip formed thereon, can be compared to an expected amount of wear of the user's legitimate credit card. The comparison can be performed substantially in real time, e.g., as the suspect credit card is being used. When it is determined that the suspect credit card is a fake, the transaction can be declined and the fake credit card can be confiscated.

For example, when the suspect credit card is used at an automatic teller machine (ATM) or at a point of sale (POS), the amount of wear of the magnetic strip of the suspect credit card can be compared to the known amount of wear of the user's legitimate credit card. The amount of wear of the legitimate credit card can be known from one or more previous uses of the legitimate credit card. The suspect credit card should have at least as much wear as the amount of wear of the legitimate credit card the last time that the legitimate credit card was used.

If the amount of wear of the suspect credit card is less than the amount of wear of the legitimate credit card, then it can be assumed that the suspect credit card is a fraudulent or fake copy of the legitimate credit card. If the amount of wear of the suspect credit card is less than the amount of wear of the legitimate credit card, then the suspect credit card (and the legitimate credit card as well, since they both have the same credit card number and are somewhat indistinguishable from one another) can be deactivated. Alternatively, the legitimate credit card can remain activated, e.g., in use.

Credit cards and the like typically have a magnetic strip that is read by a card reader when a purchase is made or an ATM transaction is conducted. For example, either the user or a checkout clerk of a merchant can swipe the credit card to effect reading of information contained on the magnetic strip. The credit card can be swiped during an ATM transaction or the like. For example, the credit card can be swiped during a cash withdrawal transaction from the ATM. The information can identify the user and/or an account of the user so that the purchase or withdrawal can be properly accounted for with respect to the user and/or the account.

Such magnetic strips are subject to wear over time. As the credit card is used, damage due to wear accumulates over time. The wear can be physical wear to the layer of material that defines the magnetic strip. Credit cards typically use an iron oxide layer or the like to form the magnetic strip. The magnetic strips of credit cards can be defined by the International Organization for Standardization (ISO) as spelled out in ISO/IEC 7810, ISO/IEC 7811, ISO/IEC 7812, ISO/IEC 7813, ISO 8583, and ISO/IEC 4909. These standards define the physical properties of the magnetic strip. They also define the magnetic characteristics of the material used to make the magnetic strip, as well as the data formats used to store the information thereon.

The magnetic strip can abrade from usage. The magnetic strip can rub against a read head or other parts of the credit card reader as the magnetic strip passes thereby during a reading process. This intimate contact of the magnetic strip with the read head can cause the layer of iron oxide to wear, e.g., abrade away. The amount of such wear can substantially affect reading of the magnetic strip in a manner that can be characterized, as discussed herein.

The wear can be magnetic wear to the magnetic domains of the iron oxide layer. The orientation of these magnetic domains defines the information stored in the magnetic layer. Over time, the orientation of the domains tends to change. Physical wear, heat, and magnetic fields can hasten such magnetic wear. Again, the amount of wear can affect reading of the magnetic strip in a manner that can be characterized, as discussed herein.

More particularly, the wear can make the magnetic strip more difficult to read over time. Such difficulty in reading the magnetic strip can result in more attempts by the card reader to read the magnetic strip, i.e., more re-reads. Such difficulty in reading the magnetic strip can result in more use of error detection and correction. Such difficulty in reading the magnetic strip can result in the need for the reader to read or rely up redundant information, such as in a secondary or tertiary strip or portion of the credit card. The experiencing of any of these difficulties can be a measurable indication of wear. The degree to which any of these difficulties is experienced can be an indication of the amount of wear.

When the card reader fails to properly read the information on a credit card the first time, the credit card can be re-read a plurality of times. That is, the magnetic strip can be made to pass over the read head of the card reader a plurality of times. Often, such plural reading of the magnetic strip will result in a proper reading thereof. Generally, the more wear the magnetic has, the more re-reads that are necessary.

Error detection and correction protocols are commonly used to better facilitate reliable reading of the information from credit cards. Such error detection and correction protocols take advantage of a level of redundancy built into the information during the information writing process. Such error detection and correction protocols can, at least to some degree, compensate for wear to the magnetic strip. Generally, the more wear the magnetic has, the more use of the error detection and correction protocol that is necessary. Longitudinal redundancy check (LRC) is one example of such an error detection and correction protocol.

Generally, the longer the credit card has been in use, the more wear the magnetic strip has incurred. Thus, the longer the credit card has been in use the more difficult it will be to read the magnetic stip. As such, wear can provide some indication of the age of the credit card. For example, wear can provide a generally reliable indication of whether the credit card is new or instead has been in use for some time.

For example, an older, well-worn magnetic strip may require more re-reads and/or more use of the error detection and correction protocol as compared to a new credit card. Embodiments can take advantage of this characteristic of credit card magnetic strips to better recognize and thwart credit card fraud.

The magnetic strip, a portion of the magnetic strip, or a separate magnetic strip can be configured to be more readily degradable and/or more uniformly degradable as compared to the magnetic strip of a contemporary credit card. That is, the magnetic strip, a portion of the magnetic strip, or a separate magnetic strip can be less robust with respect to wear so as to provide an enhanced indication of the age of the credit card.

One or more additional such magnetic strips can be added to the credit card to better determine wear. In order to better facilitate reliable reading of the information from credit cards while also providing an enhance indication of the age thereof, multiple magnetic strips can be provided. The information contained on such multiple magnetic strips can be at least somewhat redundant.

The wear can be on a portion of the credit card other than the magnetic strip. For example, the wear can be on the front or back of the credit card. Such wear on other than the magnetic strip can be determined, measured, or sensed by any suitable means. For example, such wear can be determined by attempting to perform optical character recognition on the front or back of the credit card. Any failure to recognize letters on the face of the credit card can be an indication of wear. Thus, the wear can be associated with at least one visual feature, e.g., alphanumeric printing, of the credit card

More particularly, the results of optical character recognition on the credit card can be compared to known text of the credit card. Differences between the results of the optical character recognition and the known text can indicate wear of the credit card. For example, each unrecognized character can be a further indication of wear.

Information other than wear can be used, such as in combination with wear, to determine whether or not a credit card is legitimate. For example, the geographic location, description of the user, types of products purchased, and the like can be used in combination with wear to determine whether or not a credit card is legitimate.

A fake credit card generally has little or no wear, particularly during the first few uses thereof. Generally, a fake credit can is a recently fabricated credit can and is therefore new, e.g., has substantially no wear. Thus, the difference in the amount of wear between a fake credit card and a legitimate credit card can be substantial. The fake credit card will generally have a substantially different path of degradation or wear history as compared to a legitimate credit card. Multiple paths of degradation (such as between a fake credit card and a legitimate credit card) can be a reliable indication that a credit card has been copied. Multiple paths of degradation tend to indicate the existence of multiple credit cards, such as a legitimate credit card and one or more fake credit cards. Thus, credit card fraud can be detected by tracking the wear history of the magnetic strip of a credit card.

According to an embodiment, the wear of the magnetic strip of a credit card currently being used can be compared to the historic wear of the credit card to determine, at least in part, whether or not the credit card is a legitimate credit card or a fake credit card. More particularly, the credit card fraud detection system can determine and record an amount of wear of the magnetic strip (or other portion) of the credit card of the user. When the credit card is used, the amount of wear determined for the present use can be compared to the amount wear for a previous use, e.g., the last use. If the amount of wear for the current use is approximately the same or more than the amount of wear for the previous use, then the credit card can be determined to be a legitimate credit card since increased wear is expected over time.

If the amount of wear for the current use is less than the amount of wear for the previous use, then the credit card can be determined to be an approximately new, e.g., fake credit card, since the credit card lacks the expected wear. A threshold can be defined such that the amount of wear for the current use must be less by the amount of the threshold to account for inaccuracy in the wear determination process. That is, a tolerance can be defined within which the wear is not considered to be significant enough to justify a determination that a credit card is a fake. For example, if the amount of wear for the current use is only slightly less (within the threshold or tolerance amount) than the amount of wear for the previous use, then the credit card can be determined to be legitimate. In this manner, variations in readers, physical characteristics of credit cards, temperature, and another other factors that can affect the accuracy of wear determination can be accommodated.

According to an embodiment, a system can comprise one or more memories storing an account of the user. The account can include a credit card number of the credit card of the user and an indication of a previous amount of wear of a magnetic strip of the credit card. For example, the indication of the previous amount of wear of the magnetic strip can be from a previous use of the credit card. The indication of the previous amount of wear of the magnetic strip can be from the last use of the credit card.

One or more processors can be operable to receive a communication including the credit card number and an indication of a present amount of wear of a suspect magnetic strip associated with the credit card number. The one or more processors can determine if the present amount of wear is less than the previous amount of wear. The one or more processors can deactivate the credit card if the present amount of wear is less than the previous amount of wear.

Determining if the present amount of wear is less than the previous amount of wear can comprise determining if the present amount of wear is approximate zero. A present amount of wear of the magnetic strip can indicate that the suspect credit card is an unauthorized new copy of the legitimate credit card.

The present amount of wear and the previous amount of wear can determined for a predefined portion of the magnetic strip. For example, the present amount of wear and the previous amount of wear can be determined for a strip that is used only to determine wear of the credit card and that is not used to contain credit card information. Thus, the present amount of wear and the previous amount of wear can be determined for a predefined portion of the magnetic strip that contains information that is unrelated to the credit card account.

The indication of the present amount of wear can comprise information regarding the number of re-reads and/or the use of an error detection and correction protocol. The indication of the present amount of wear can comprise information regarding a use of a longitudinal redundancy check error detection and correction protocol, for example. Thus, the present amount of wear and the previous amount of wear can be determined from at least one of a number of re-reads and amount of error detection required to read the suspect magnetic strip during a transaction, such as a point of sale or ATM transaction.

According to an embodiment, a method can comprise storing, in one or more memories, an account of the user. The account can include a credit card number of a credit card of the user and an indication of a previous amount of wear of a magnetic strip of the credit card. A communication can be received, such as electronically via one or more processors. The communication can include the credit card number and an indication of a present amount of wear of a suspect magnetic strip associated with the credit card number.

The one or more processors can determine whether or not the present amount of wear is less than the previous amount of wear. The one or more processors can effect deactivation of the credit card if the present amount of wear is less than the previous amount of wear, thus indicating that the credit card is likely a fake.

According to an embodiment, a computer program product can comprise a non-transitory computer readable medium. The non-transitory computer readable medium can have computer readable and executable code for instructing one or more processors to perform any of the methods discussed herein.

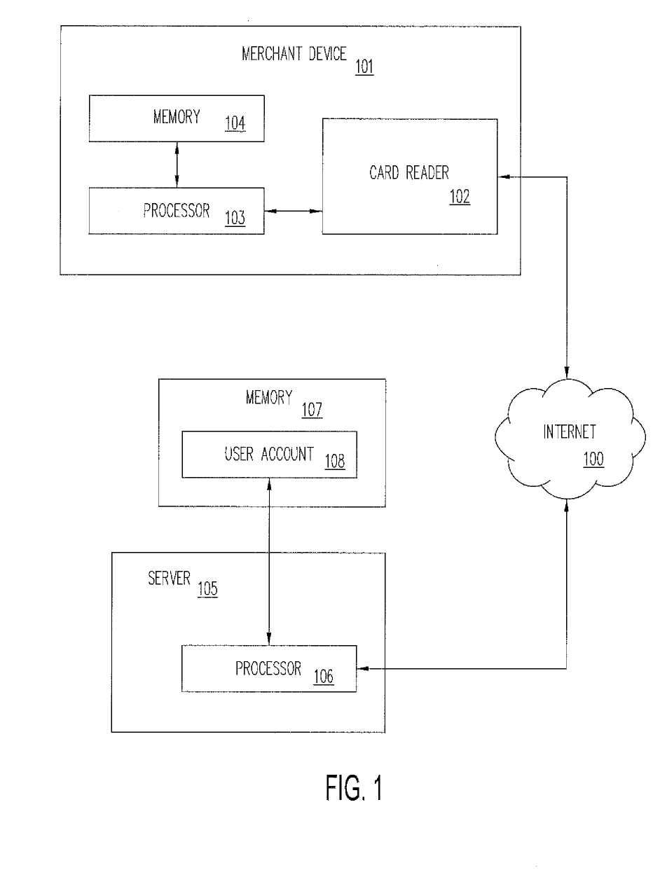

FIG. 1 is a block diagram of a system for detecting credit card fraud, according to an embodiment. The system can include a merchant device 101. The merchant device can include a card reader 102, a processor 103, and a memory 104. The card reader 102 can read credit cards and the like.

The merchant device 101 can be a merchant checkout terminal, a point of sale (POS) system, or an automated teller machine (ATM), for example. The merchant device 101 can be any device that includes the card reader 102. The merchant device 101 can be a cellular telephone and the card reader 102 can be a mobile card reader such as a PayPal Here card reader.

The merchant device 101 can be used for facilitating credit card transactions, for facilitating ATM transaction, or the like. The merchant device 101 can be used for measuring, determining, or monitoring the wear of the magnetic strip (or other part) of the user's credit card. The processor 103 can use instructions stored in the memory 104 to read the magnetic strip of a credit card and to determine the amount of wear on the magnetic strip of the credit card.

The system can include a server 105. The server 105 can be a server of a payment provider, such as PayPal, Inc. The server 105 can be a server of a credit card company, a bank, a credit card fraud prevention company, and/or any other entity. The server 105 can be a single server or can be a plurality of servers.

The server 105 can include one or more processors 106 and a memory 107. The memory 107 can be a memory of the server 105 or a memory that is associated with the server 105. The memory 107 can be a distributed memory. The memory 107 can store a user account 108. The user account 108 can include information regarding the user's credit card. The information can include a transaction history and a wear history for the user's credit card. The memory 107 can store any desired number of user accounts, transaction histories, and wear histories.

The server 105 can receive a communication from the merchant device 101. The communication can include information regarding a transaction involving the user's credit card. The communication can include information regarding an amount of wear, such as a current amount of wear, of the magnetic strip of the user's credit card.

The server 105 can be used for facilitating credit card and ATM transactions. The server 105 can be used for storing a history of the wear of the magnetic strip of the user's credit card. For example, the memory 107 of the server 105 can be used for maintaining a database of user's credit card accounts including the wear history associated with each magnetic strip of each credit card.

The merchant device 101 and the server 105 can communicate with one another, at least partially, via a network, such as the Internet 100. The merchant device 101 and the server 105 can communicate with one another, at least partially, via one or more networks, such as local area networks (LANs), wide area networks (WANs), cellular telephone networks, and the like. The merchant device 101 and the server 105 can communicate with one another, at least partially, via one or more near field communications (NFC) methods or other short range communications methods, such as infrared (IR), Bluetooth, WiFi, and WiMax.

FIG. 1 illustrates an exemplary embodiment of a network-based system for implementing one or more processes described herein. As shown, the network-based system may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIXO OS, a LINUX® OS, or another suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

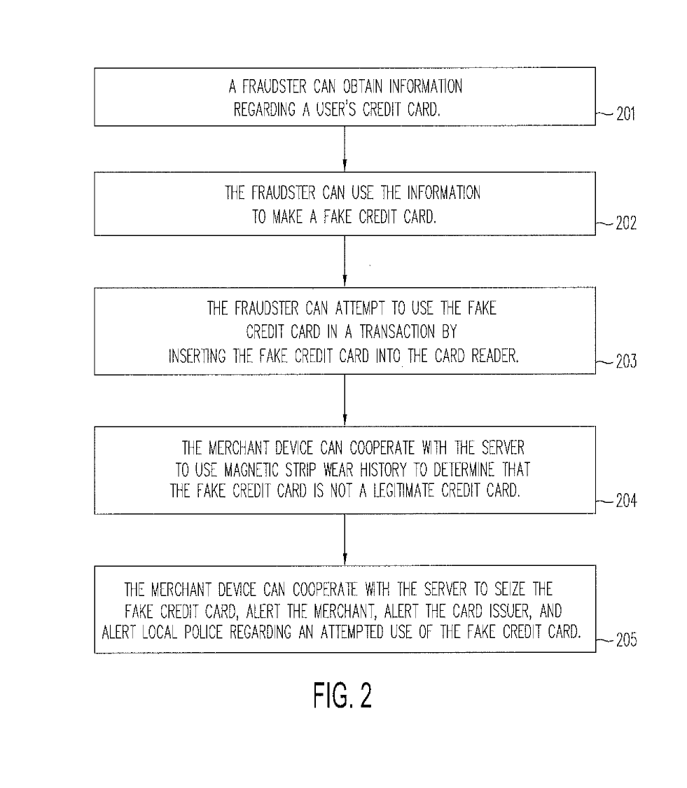

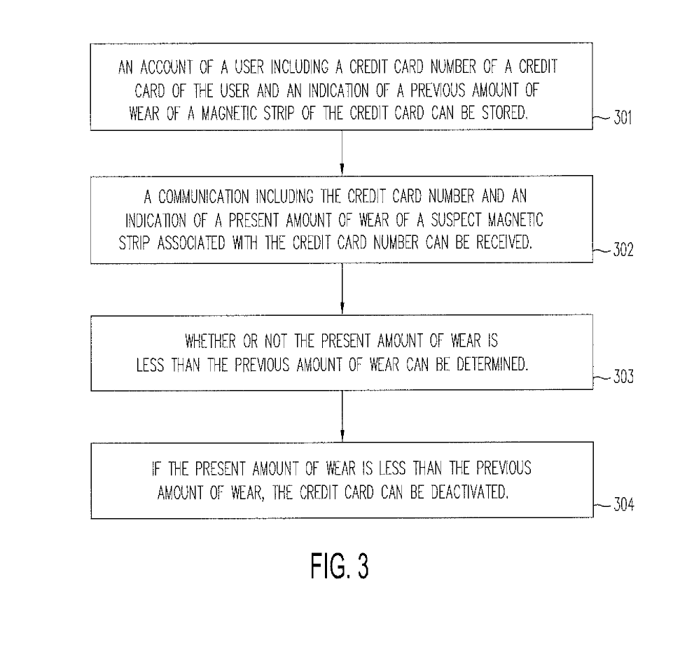

FIGS. 2 and 3 are flow charts that describe examples of operation of the method for detecting credit card fraud according to embodiments thereof. Note that one or more of the steps described herein may be combined, omitted, or performed in a different order, as desired or appropriate.

FIG. 2 is a flow chart showing the method for detecting credit card fraud, according to an embodiment. A fraudster can obtain information regarding a user's credit card, as shown in step 201. The fraudster can obtain the information indirectly, such as by hacking an online database, for example. Instances of such hacking are widespread and well-know. By hacking an online database, a fraudster can obtain credit card numbers, expiration dates, cardholder's names, and security information. The information can be used by the hacker to make a fake credit card and/or the information can be sold to another fraudster who can make a fake credit card using the information.

The fraudster can obtain the information directly, such as from the user's credit card. User's frequently give their credit cards to other people, who can be complete strangers with respect to the user and any of which can be a fraudster. For example, users frequently give their credit cards to waitresses and waiters for paying a bill at a restaurant. The fraudster can use this opportunity to manually or electronically capture the information. Again, the information can be used by the hacker to make a fake credit card and/or the information can be sold to another fraudster who can make a fake credit card using the information.

Thus, the fraudster can use the information to make a fake credit card, as shown in step 202. Machines for embossing credit cards, machines for printing upon credit cards, and machines for writing information to the magnetic strips of credit cards can be obtained by fraudsters. Once the user's credit card information has been obtained by the fraudster, this information can be used by the fraudster to make a copy of the user's credit card. The copy or fake credit card can be substantially identical to the user's legitimate credit card.

However, one discernible difference between the fake credit card and the legitimate credit card can be the amount of wear on the magnetic strips thereof. The magnetic strip (or other part) of user's legitimate credit card will generally have substantial wear from repeated uses, e.g., many readings by a card reader. By way of contrast, the magnetic strip (or other part) of the newly made fake credit will typically have little or no wear.

The fraudster can attempt to use the fake credit card in a transaction by inserting the fake credit card into the card reader 102, as shown in step 203. The transaction can be a point of sale purchase of a product or can be an ATM withdrawal, for example. In either instance, the fraudster will typically be required to insert the fake credit card into the card reader 102.

The merchant device 101 can cooperate with the server 105 to use magnetic strip wear history to determine that the fake credit card is not a legitimate credit card, as shown in step 204. For example, a communication including the credit card number and an indication of the present wear determined to be on the fake credit card can be sent to the server 105. The server 105 can use the credit card number to look up the wear history of the user's legitimate credit card in the user account 108. If the present wear is not consistent with the wear history, then the credit card being read by the card reader 102 can be determined to be a fake credit card.

The merchant device 101 can cooperate with the server 105 to seize the fake credit card, alert the merchant, alert the card issuer, and alert local police regarding an attempted use of the fake credit card, as shown in step 205. Thus, the fake credit card can be seized and the fraudster can be caught on the first use of the fake credit card. Generally, all credit cards, including the user's legitimate credit card, with the same credit card number will be deactivated. In this manner, the use of any other fake credit cards with the same credit card number will be substantially inhibited. Alternatively, the user's legitimate credit card can remain activated.

FIG. 3 is a flow chart showing further detail of the method for detecting credit card fraud, according to an embodiment. An account of a user, including information such as a credit card number of a credit card of the user and an indication of a previous amount of wear of a magnetic strip of the credit card can be stored, as shown in step 301. The information can be stored in the memory 107 of the server 105. More particularly, the information can be stored in the user account 108.

A communication including the credit card number and an indication of a present amount of wear of a suspect magnetic strip associated with the credit card number can be received, such as by the server 105 and from the merchant device 101, as shown in step 302. The server 106 can be remotely located with respect to the merchant device 101. For example, the server 106 can be a credit card company server, a bank server, or a payment provider server that cooperates with a plurality, e.g., a large number, of merchant devices to facilitate credit card transactions and the like. The server 106 can be collocated located with respect to the merchant device 101.

Whether or not the present amount of wear less is than the previous amount of wear can be determined, as shown in step 303. Whether or not the present amount of wear less than the previous amount of wear can be determined by the merchant device 101, the server 105, the merchant device 101 in cooperation with the server 105, and/or any other system or device.

The present amount of wear on the magnetic strip of the credit card can be determined from the number or re-reads, amount of error detection and correction, the physical condition of the magnetic strip (as sensed by a magnetic sensor, e.g., a magnetometer, as sensed by a read head, as sensed by an imaging sensor, or as sensed by any other means) or by any other method for sensing wear on a magnetic strip.

If the present amount of wear is less than the previous amount of wear, the credit card can be determined to be a fake credit card and can be deactivated, as shown in step 304. The credit card can be determined to be a fake credit card if the wear of magnetic strip is less than, equal to, or within a predetermined amount with respect to the magnetic strip of the legitimate credit card.

This determination can be made with respect to the last use of the legitimate credit card or the last plurality of uses of the legitimate credit card. For example, the determination can be made with respect to an average of the last plurality (e.g., 2, 3, 5, 10, 25, 50, or 100) of uses of the legitimate credit card. As a further example, the determination can be made with respect to an exponentially weighted average of the last plurality (e.g., 2, 3, 5, 10, 25, 50, or 100) of uses of the legitimate credit card. Such an exponentially weighted average of the last plurality of uses of the legitimate credit card can give more weight to the more recent uses of the legitimate credit card than to earlier uses of the legitimate credit card and can thus more likely provide a more accurate determination of the present wear of the legitimate credit card.

Not all merchant devices 101 may be capable of providing an indication of the wear of the magnetic strip of the user's credit card. When there have been one or more uses of the user's legitimate credit card on such merchant devices 101, then an estimate or expected value of the wear of the legitimate credit card can be determined. The estimate or expected value of the wear of the legitimate credit card can be determined, at least in part, upon the number of uses. For example, if the user's legitimate credit card has experience a given (determined) amount of wear over the last ten uses thereof and the user's legitimate credit card is subsequently used ten more times with merchant devices 101 that are incapable of providing an indication of wear, then the last ten uses (for which no wear determination was made) can be assumed to provide approximately the same amount of wear as the prior ten uses (for which a wear determination was made).

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Payment processing can be through known methods, such as transaction details being communicated to the payment provider through the app, the payment provider processing the details, which may include user account and identifier information and authentication, merchant information, and transaction details. The user account may be accessed to determine if any restrictions or limitations may prevent the transaction from being approved. If approved, the payment provider may send a notification to the merchant and/or the user.

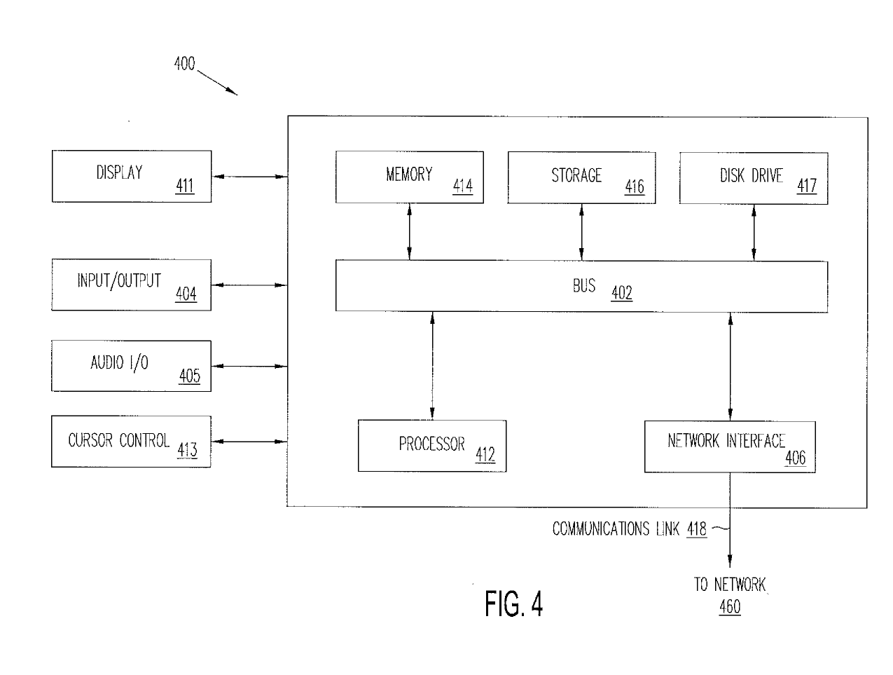

FIG. 4 is a block diagram of a computer system 400 suitable for implementing one or more embodiments of the present disclosure. In various implementations, the PIN pad and/or merchant terminal may comprise a computing device (e.g., a personal computer, laptop, smart phone, tablet, PDA, Bluetooth device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as a user device, a merchant server, or a payment provider server via network 460. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another.

Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

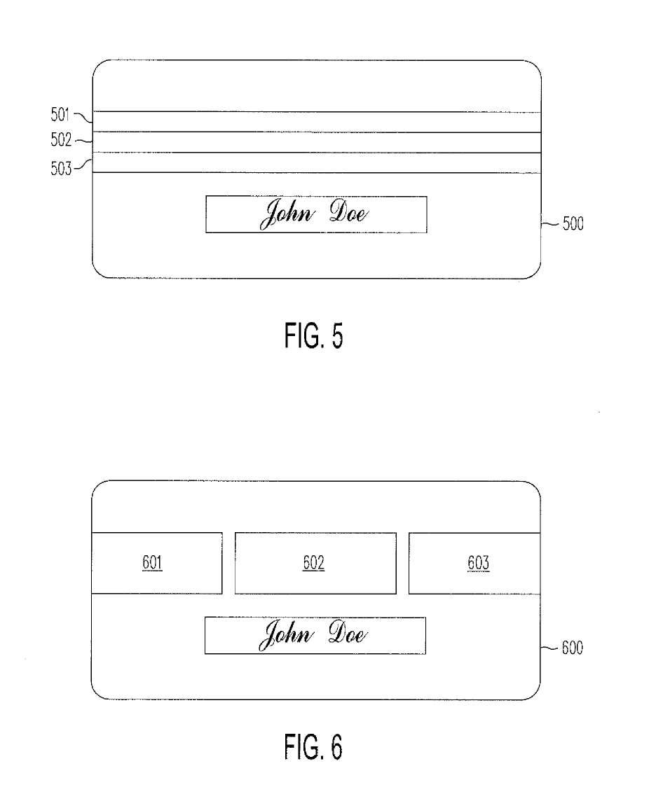

According to embodiments, the credit card fraud detection methods and systems can be practiced using contemporary, unmodified credit cards and the like. Alternatively, credit cards and the like can be modified, such as discussed with respect to FIGS. 5 and 6 below, to better facilitate credit card fraud detection.

FIG. 5 shows a credit card 500 configured for detecting credit card fraud, according to an embodiment. The credit card 500 can have a plurality of magnetic strips 501, 502, and 503 formed thereon. One of the magnetic strips 501, 502, and 503 can be configured to better facilitate detection of wear thereto. Thus, a well-used credit card can more readily be distinguished from a relatively new credit card.

For example, the credit card 500 can have the three magnetic strips 501, 502, and 503 formed horizontally thereon. The three magnetic strips 501, 502, and 503 can be formed generally parallel with respect to one another.

Two of the magnetic strips, such as magnetic strips 501 and 502, can have credit card information stored thereon. For example, this can be the standard credit card information stored on a contemporary credit card. The two magnetic strips 501 and 502 can be substantially redundant with respect to one another. For example, the two magnetic strips 501 and 502 can each contain substantially the same information.

A third magnetic strip, such as magnetic strip 503, can be specifically configured for use or wear determination. The third magnetic strip 503 can contain credit card information, other information, or no information. The third magnetic strip 503 can contain any desired information.

The magnetic strip 503 can be configured to more readily show wear. Thus, magnetic strip 503 can wear more quickly, more uniformly (such as along the surface thereof), at a more uniform rate, and/or at more predictable rate. The wear of the magnetic strip 503 can be more readily determined as compared to the ware of the magnetic strips 501 and 502.

The magnetic strip 503 can be less durable as compared to magnetic strips 501 and 502. The magnetic strip 503 can wear more quickly by making the iron oxide coating less durable. Magnetic strips 501 and 502 can have a protective and/or lubricating coating while magnetic strip 503 can lack such a protective and/or protective coating. The iron oxide or other coating of the magnetic strip 503 can be thinner and thus more susceptible to wear as compared to the magnetic strips 501 and 502. As a further example, a less durable compound of iron oxide, adhesive, or polymer can be used.

According to an embodiment, the wear can be more readily determined by storing information on the magnetic strip 503 that more readily indicates wear. The information can be information that is unrelated to the credit card account. For example, all binary ones can be stored in the magnetic domains of the magnetic strip 503. Thus, any reading of a binary zero in a magnetic domain of the magnetic strip 503 can be an indication of wear. The reading of a binary zero in a magnetic domain of the magnetic strip 503 can be an indication of physical wear or can be an indication of magnetic wear.

As a further example, alternating binary ones and binary zeroes can be stored in the magnetic domains of the magnetic strip 503. Thus, any reading of two or more ones in a row or two or more binary zeroes in row can be an indication of wear. Such a reading can be an indication of physical wear or can be an indication of magnetic wear.

FIG. 6 shows a credit card 600 configured for detecting credit card fraud, according to an embodiment. The credit card 600 can have a plurality of magnetic strips 601, 602, and 603 formed thereon. One of the magnetic strips 601, 602, and 603 can be configured to better facilitate detection of wear thereto. Thus, a well-used credit card can more readily be distinguished from a relatively new credit card.

For example, the credit card 600 can have the three magnetic strips 601, 602, and 603 formed horizontally thereon. The three magnetic strips 601, 602, and 603 can be formed generally serially, e.g., in line with respect to one another.

Two of the magnetic strips, such as magnetic strips 601 and 602, can have credit card information stored thereon. This can be the standard credit card information stored on a contemporary credit card. The two magnetic strips 601 and 602 can be substantially redundant with respect to one another. For example, the two magnetic strips 601 and 602 can each contain substantially the same information.

A third magnetic strip, such as magnetic strip 603, can be specifically configured for use or wear determination. The third magnetic strip 603 can contain credit card information, other information, or no information.

The magnetic strip 603 can be configured to more readily show wear. Thus, magnetic strip 603 can wear more quickly, more uniformly (such as along the surface thereof), at a more uniform rate, and/or at more predictable rate. The wear of the magnetic strip 603 can be more readily determined as compared to the ware of the magnetic strips 601 and 602.

The magnetic strip 603 can be less durable as compared to magnetic strips 601 and 602. The magnetic strip 603 can wear more quickly by making the iron oxide coating less durable. Magnetic strips 601 and 602 can have a protective and/or lubricating coating while magnetic strip 603 can lack such a protective and/or protective coating. The iron oxide or other coating of the magnetic strip 603 can be thinner and thus more susceptible to wear as compared to the magnetic strips 601 and 602. As a further example, a less durable compound of iron oxide, adhesive, or polymer can be used.

According to an embodiment, the wear can be more readily determined by storing information on the magnetic strip 603 that more readily indicates wear. The information can be information that is unrelated to the credit card account. For example, all binary ones can be stored in the magnetic domains of the magnetic strip 603. Thus, any reading of a binary zero in a magnetic domain of the magnetic strip 603 can be an indication of wear. The reading of a binary zero in a magnetic domain of the magnetic strip 603 can be an indication of physical wear or can be an indication of magnetic wear.

As a further example, alternating binary ones and binary zeroes can be stored in the magnetic domains of the magnetic strip 603. Thus, any reading of two or more binary ones in a row or two or more binary zeroes in row can be an indication of wear. Such a reading can be an indication of physical wear or can be an indication of magnetic wear.

The credit card 500, 600 can comprise a strip that has a plurality of different portion and the different portions can wear at different rates. For example, the magnetic strip 503 of credit card 500 or magnetic strip 603 of credit card 600 can contain 2, 3, 5, 10, 25 or more portions and each portion can have a different durability. Generally, one portion can wear substantially or completely through before another portion shows substantial wear. The portions can be arranged in order of durability, such that a first portion wears substantially before a second portion, the second portion wears substantially before a third portion, and so on. Each portion can have information, such as all binary ones, stored thereon. The amount of wear for magnetic strip 503, 603 can be determined by how many and/or which of the portion have worn.

Thus, wear of the credit card and particularly of the magnetic strip 503, 603 can more readily be detected. In this manner, the fraudulent use of a newly made credit card can be more readily detected. Any such newly made credit card can be promptly deactivated. The newly made credit card can be deactivated before it can be used in a purchase transaction or an ATM transaction.

The present wear and the previous wear can be determined by the same method. For example, both the present wear can the previous wear can be determined by the number of re-reads combined with the amount of error detection and correction required for a successfully read of the magnetic strip. Using the same method provides consistency and reliability in the wear determination process. Alternatively, different methods can be used to determine the present wear and the previous wear.

As used herein, the term “store” can include any business or place of business. The store can be a brick and mortar store or an online store. The store can be any person or entity that sells a product.

As used herein, the term “product” can include any item or service. Thus, the term “product” can refer to physical products, digital goods, services, or anything for which a user can make a payment, including charitable donations. A product can be anything that can be sold. Examples of products include cellular telephones, concerts, meals, automotive repair, haircuts, digital music, and books.

As used herein, the term “merchant” can include any seller of products. The term merchant can include a store. The products can be sold from a store or in any other manner.

As used herein, the term “network” can include one or more local area networks (LANs) such as business networks, one or more wide area networks (WANs) such as the Internet, one or more cellular telephone networks, or any other type or combination of electronic or optical networks.

As used herein, the term “credit card” can include a credit card, bank card, debit card, gift card, or the like. The term “credit card” can include any card with a machine readable portion, such as a magnetic strip, that is subject to wear as the card is read.

As used herein, the term “suspect credit card” can include a credit card for which the authenticity is in question. Thus, a suspect credit card may be a fake credit card or may be a legitimate credit card.

As used herein, the term “suspect magnetic strip” can include a magnetic strip for a credit card for which the authenticity is in question. Thus, a suspect credit card may be a fake credit card or may be a legitimate credit card.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A system comprising:
one or more memories storing an account of a user, the account including a credit card number of a credit card of the user and an indication of a previous amount of wear of the credit card;
one or more processors operable to:
receive a communication including the credit card number and an indication of a present amount of wear associated with the credit card number;
determine, at least partially from the account, if the present amount of wear is less than the previous amount of wear; and
deactivate the credit card if the present amount of wear is less than the previous amount of wear.

2. The system of claim 1, wherein the previous amount of wear is for a magnetic strip of the credit card and wherein the present amount of wear is for a magnetic strip associated with the credit card number.

3. The system of claim 1, wherein the previous amount of wear and the present amount of wear are associated with at least one visual feature of the credit card.

4. The system of claim 1, wherein determining if the present amount of wear is less than the previous amount of wear comprises determining if the present amount of wear is approximate zero.

5. The system of claim 2, wherein the present amount of wear and the previous amount of wear are for a predefined portion of the magnetic strip.

6. The system of claim 2, wherein the present amount of wear and the previous amount of wear are for a predefined portion of the magnetic strip and the predefined portion contains information that is unrelated to the account.

7. The system of claim 1, wherein the indication of the present amount of wear comprises information regarding a use of an error detection and correction protocol.

8. The system of claim 1, wherein the indication of the present amount of wear comprises information regarding a use of a longitudinal redundancy check error detection and correction protocol.

9. The system of claim 2, wherein the present amount of wear and the previous amount of wear are determined from at least one of a number of re-reads and amount of error detection required to read the suspect magnetic strip.

10. A method comprising:
storing, in one or more memories, an account of a user, the account including a credit card number of a credit card of the user and an indication of a previous amount of wear of the credit card;
receiving, electronically via one or more processors, a communication including the credit card number and an indication of a present amount of wear associated with the credit card number;
determining, electronically via the one or more processors, if the present amount of wear is less than the previous amount of wear; and
deactivating, electronically via one or more processors, the credit card if the present amount of wear is less than the previous amount of wear.

11. The method of claim 10, wherein the previous amount of wear is for a magnetic strip of the credit card and wherein the present amount of wear is for a magnetic strip associated with the credit card number.

12. The method of claim 10, wherein the previous amount of wear and the present amount of wear are associated with at least one visual feature of the credit card.

13. The method of claim 10, wherein determining if the present amount of wear is less than the previous amount of wear comprises determining if the present amount of wear is approximate zero.

14. The method of claim 11, wherein the present amount of wear and the previous amount of wear are for a predefined portion of the magnetic strip.

15. The method of claim 11, wherein the present amount of wear and the previous amount of wear are for a predefined portion of the magnetic strip and the predefined portion contains information that is unrelated to the account.

16. The method of claim 10, wherein the indication of the present amount of wear comprises information regarding a use of an error detection and correction protocol.

17. The method of claim 10, wherein the indication of the present amount of wear comprises information regarding a use of a longitudinal redundancy check error detection and correction protocol.

18. The method of claim 11, wherein the present amount of wear and the previous amount of wear are determined from at least one of a number of re-reads and amount of error detection required to read the suspect magnetic strip.

19. A computer program product comprising a non-transitory computer readable medium having computer readable and executable code for instructing one or more processors to perform a method, the method comprising:
storing an account of a user, the account including a credit card number of a credit card of the user and an indication of a previous amount of wear of the credit card;
receiving a communication including the credit card number and an indication of a present amount of wear associated with the credit card number;
determining if the present amount of wear is less than the previous amount of wear; and
deactivating the credit card if the present amount of wear is less than the previous amount of wear.

20. The computer program product of claim 19, wherein the previous amount of wear is for a magnetic strip of the credit card and wherein the present amount of wear is for a magnetic strip associated with the credit card number.

21. The computer program product of claim 19, wherein the previous amount of wear and the present amount of wear are associated with at least one visual feature of the credit card.

22. The computer program product of claim 19, wherein determining if the present amount of wear is less than the previous amount of wear comprises determining if the present amount of wear is approximate zero.

23. The computer program product of claim 20, wherein the present amount of wear and the previous amount of wear are for a predefined portion of the magnetic strip.

24. The computer program product of claim 20, wherein the present amount of wear and the previous amount of wear are for a predefined portion of the magnetic strip and the predefined portion contains information that is unrelated to the account.

25. The computer program product of claim 19, wherein the indication of the present amount of wear comprises information regarding a use of an error detection and correction protocol.

26. The computer program product of claim 19, wherein the indication of the present amount of wear comprises information regarding a use of a longitudinal redundancy check error detection and correction protocol.

27. The computer program product of claim 20, wherein the present amount of wear and the previous amount of wear are determined from at least one of a number of re-reads and amount of error detection required to read the suspect magnetic strip.
